(19) United States
(12) Patent Application Publication
(10) Pub. No.: US 2004/0169834 A1
(43) Pub. Date: Sep. 2, 2004

(54) Optical device for use with a lithography method

(75) Inventors: Ernst-Christian Richter, Dresden (DE); Michael Sebald, Weisendorf (DE)

Correspondence Address: MORRISON & FOERSTER LLP, 1650 TYSONS BOULEVARD, SUITE 300, MCLEAN, VA, 22102, US

(73) Assignee: Infineon Technologies AG, Munchen (DE)

(21) Appl. No.: 10/713,765

(22) Filed: Nov. 17, 2003

(30) Foreign Application Priority Data
Nov. 18, 2002 (DE) 10253679.1

(51) Int. Cl. G03B 27/54

(52) U.S. Cl. 355/67; 355/53; 355/30

(57) ABSTRACT

The invention relates to an optical lithography method and to an optical device for use with a lithography method. In particular the invention relates to optical devices for the production of semiconductor devices, wherein the optical device includes a lens system positioned, with respect to the optical path, behind a mask, and wherein, in an area between the mask and the lens system, a medium is provided which has a refractive index (n) greater than 1.

### CLAIM FOR PRIORITY

This application claims the benefit of and priority to German application DE 10253679.1, filed Nov. 18, 2002.

### TECHNICAL FIELD OF THE INVENTION

The invention relates to an optical device for use with a lithography method, in particular for the production of a semiconductor device, and to an optical lithography method.

### BACKGROUND OF THE INVENTION

For the production of semiconductor devices, in particular silicon semiconductor devices so-called photolithographic methods or optical lithographic methods, in particular microlithographic methods, may, for instance, be used.

With these methods, first of all, the surface of a corresponding wafer—made e.g. of monocrystalline silicon—is subject to an oxidation process, and subsequently a light-sensitive photoresist layer is applied on the oxide layer.

Subsequently, a photomask is positioned above the wafer, and an optical device including an appropriate lens system with a plurality of lens elements is positioned between the wafer and the photomask.

The photomask is provided with a structure which corresponds to the respective structure to be produced on the wafer.

Then, the photomask—and thus also the corresponding structure on the photoresist—is exposed, and then the photomask is removed again.

When the photoresist is then developed and subjected to an etching process, the exposed positions of the photoresist (and the respective positions of the oxide layer thereunder) are removed from the wafer and the non-exposed ones are left.

For exposure of the photoresist, light of a wavelength of 193 nm (or e.g. of a wavelength of 365 nm, 248 nm, 193 nm, 157 nm, etc.) may, for instance, be used.

The corresponding light beams are deflected on passing through the mask (in particular at the structure edges or gaps existing there), i.e. intensity maxima (so-called first order, second order, etc. deflection maxima) occur behind the mask—at specific angles.

When the first lens element of the lens system has a relatively large aperture, the beams representing intensity maxima of higher order (e.g. second order and higher order) will also be covered or collected, respectively, by the corresponding lens element (thus improving the quality of the structure image projected on the wafer).

However, the above-mentioned beams representing intensity maxima of higher order hit—after passing through the last lens element—the surface of the wafer at a relatively large angle and are therefore (if the angle of incidence is larger than the total reflection critical angle) reflected at the air/wafer interface (and can then not contribute to the above-mentioned quality improvement of the structure image projected on the wafer).

To prevent this, it has been suggested to fill the area between the last lens element and the wafer with a so-called immersion liquid, e.g. water (cf. e.g. M. Switkes and M. Rothschild: “Resolution Enhancement of 157 nm Lithography by Liquid Immersion,” Proceedings of SPIE Vol. 4691 (2002), p. 459).

Since the immersion liquid has a refractive index differing from that of air, in particular a higher refractive index, a larger total reflection critical angle results for the immersion liquid/wafer interface than for the above-mentioned air/wafer interface. A total reflection can thus be prevented, and the quality of the structure image projected on the wafer can be improved.

A disadvantage of the above-mentioned proceeding is, however, that the immersion liquid gets in direct contact with the wafer or the light-sensitive photoresist layer applied thereon, respectively, and may contaminate the same.

To prevent this, an additional protective layer may, for instance, be applied on the light-sensitive photoresist (which would, however, increase the production costs and would result in a loss of quality).

### SUMMARY OF THE INVENTION

Disclosed is a novel optical device for use with a lithography method, in particular for the production of a semiconductor device, and a novel optical lithography method.

In accordance with a basic idea of the invention, an optical device for use with a lithography method, in particular for the production of a semiconductor device, is provided, including a lens system positioned, with respect to the optical path, behind a mask, with a medium being provided in an area between the mask and the lens system, said medium having a refractive index (n) greater than 1.

The relatively high refractive index (n) of the medium (e.g. of a gas or of a liquid) results in the “numerical aperture” NA of the lens system being (in accordance with the formula NA=n×sin α (with α being the aperture angle and n being the refractive index) relatively large.

Because of the relatively high numerical aperture NA—caused by the above-mentioned relatively high refractive index n—a better resolution can be obtained with the optical device according to the invention than is possible with conventional optical devices.

This enables the production of semiconductor devices having a smaller minimum structure size than in prior art.

### DETAILED DESCRIPTION OF THE INVENTION

The invention will be explained in detail by means of embodiments and the enclosed drawings, in which:

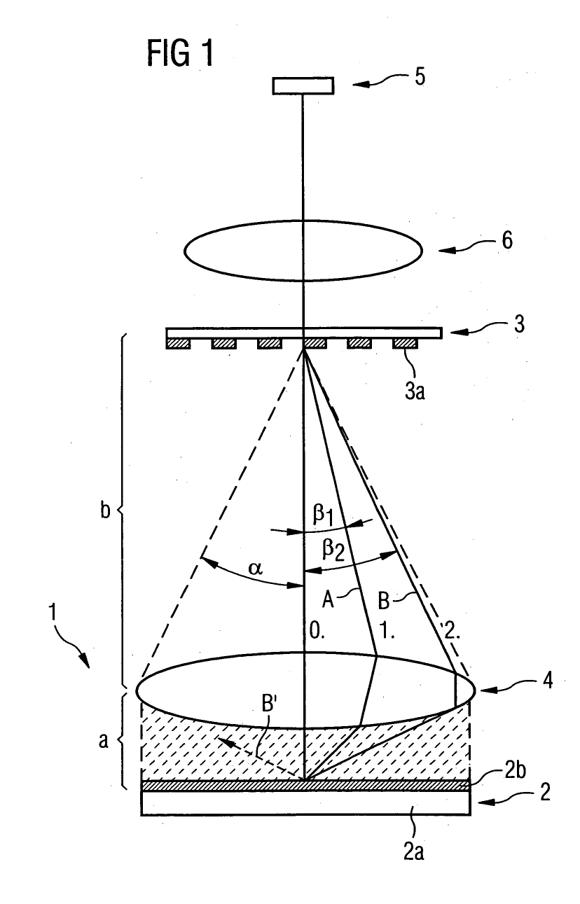

FIG. 1 shows a schematic cross-sectional view of a wafer, a mask, and an optical device for the production of semiconductor devices in accordance with prior art;

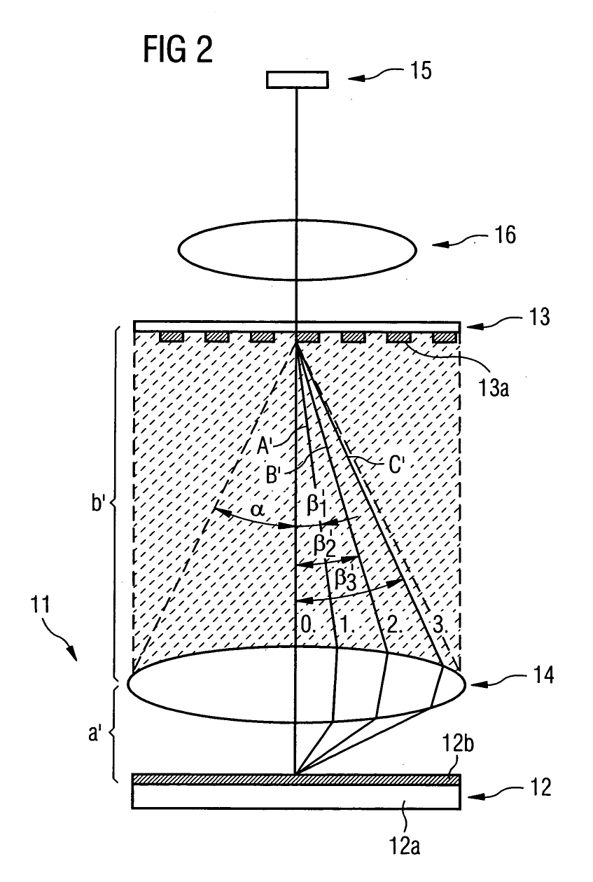

FIG. 2 shows a schematic cross-sectional view of a wafer, a mask, and an optical device for the production of semiconductor devices in accordance with a first embodiment of the present invention; and

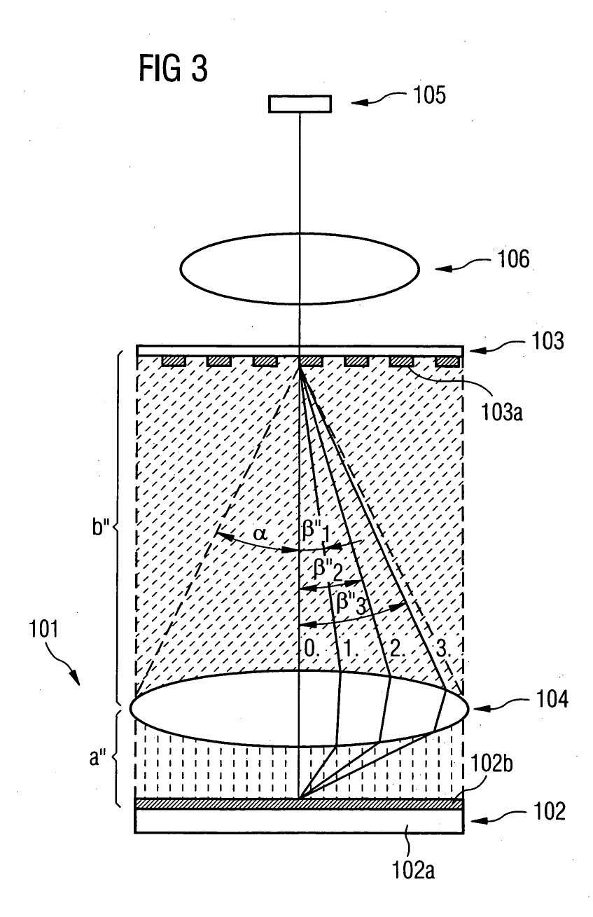

FIG. 3 shows a schematic cross-sectional view of a wafer, a mask, and an optical device for the production of semiconductor devices in accordance with a second embodiment of the present invention.

### DETAILED DESCRIPTION OF THE INVENTION

FIG. 1 is a schematic cross-sectional view of an optical device 1 for the production of semiconductor devices in accordance with prior art.

The optical device 1 includes a lens system 4 including one or a plurality of lens elements, the lens system 4 being positioned or fastened, respectively, between a photomask 3 and a wafer 2 on which the corresponding semiconductor devices are to be produced.

The wafer 2 is, for instance, manufactured of monocrystalline silicon, the surface of which was subject to an oxidation process. Then, a light-sensitive photoresist layer 2b was applied on the oxide layer 2a produced this way.

The photomask 3 is provided with a mask structure 3a which corresponds to the respective structure to be produced on the wafer 2 (wherein—as will be explained in more detail further below—the mask structure 3a is, by means of the optical device 1, projected on the wafer 2 in a correspondingly reduced way).

As is further illustrated in FIG. 1, a light source 5, e.g. an appropriate laser, is provided for exposure of the photomask 3 (and thus also of the structure on the photoresist layer 2b corresponding to the mask structure 3a) (with a further lens system 6 containing one or a plurality of lens elements in general being provided between the light source 5 and the photomask 3).

The light source 5 may, for instance, emit light of a wavelength λ0 of 193 nm (or, for instance, of a wavelength λ of 365 nm, 248 nm, 157 nm, etc.).

As is illustrated in FIG. 1, the corresponding light beams emitted by the light source 5 are deflected on passing through the photomask 3 (in particular at the edges or gaps of the mask structure 3a existing there), i.e. intensity maxima (so-called first order, second order, etc. deflection maxima, here each illustrated by beams A and B) occur behind the mask 3—at specific angles β₁, β₂, etc.

The lens system 4 (or its first lens element, respectively) has a relatively large aperture A=sin α (with α being the so-called aperture angle (cf. FIG. 1)).

Because of that, the beams A, B representing intensity maxima of higher order (here e.g. first order and second order) are also covered or collected, respectively, by the corresponding lens element, thus improving the quality of the structure image projected by the lens system 4 on the wafer 2 (more exactly: the photoresist layer 2b) (and thus enabling smaller structure widths to be realized on the wafer 2).

As is further illustrated in FIG. 1, the above-mentioned beams A and B representing intensity maxima of higher order hit—after passing through the last lens element of the lens system 4—the surface of the wafer 2 (or the photoresist layer 2b, respectively) at a relatively large angle.

To prevent a total reflection of the beams A and B at the upper face of the wafer 2 (illustrated in FIG. 1 by an arrow B′), an area a—shown in hatching in FIG. 1—between the last lens element of the lens system 4 and the wafer 2 is filled with an immersion liquid, e.g. water.

The immersion liquid has a relatively high refractive index n, in particular a higher refractive index n than the air that is, for instance, contained in an area b between the first lens element 4 and the photomask 3. The relatively high refractive index n results in a relatively large total reflection critical angle for the immersion liquid/wafer interface, thus preventing beams A and B from hitting the wafer 2 from the last lens element and reflecting at the upper face of the wafer 2.

FIG. 2 is a schematic cross-sectional view of an optical device 11 for the production of semiconductor devices in accordance with a first embodiment of the present invention.

The optical device 11 includes—in analogy to the optical device 1 illustrated in FIG. 1—a lens system 14 including one or a plurality of lens elements (connected in series), said lens system 14 being positioned or fastened, respectively, between a photomask 13 and a wafer 12 on which the corresponding semiconductor devices are to be produced.

The photomask 13 may, for instance, be a conventional photomask or, for instance—for further increasing the resolution—a phase shift mask (PSM), in particular an alternating phase shift mask (alternating PSM), an attenuated phase shift mask (attenuated PSM), etc.

The photomask 13 is provided with a mask structure 13a corresponding to the respective structure to be produced on the wafer 12 (wherein—as will be explained in more detail further below—the mask structure 13a is, by means of the optical device 11, projected on the wafer 12 in a correspondingly reduced way).

The wafer 12 is—as explained in connection with FIG. 1—manufactured e.g. of monocrystalline silicon, the surface of which was subject to an oxidation process. Then, a light-sensitive photoresist layer 12b was applied on the oxide layer 12a produced this way.

A light source 15, e.g. an appropriate laser, or e.g. a mercury vapor lamp, an argon discharge lamp, etc. is provided for exposure of the photomask 13 (and thus also of the structure on the photoresist layer 12b corresponding to the mask structure 13a) (with a further lens system 16 including one or a plurality of lens elements being provided between the light source 15 and the photomask 13).

The light source 15 may, for instance, emit light of a wavelength λ of 193 nm (or, for instance, of a wavelength λ of 365 nm, 248 nm, 157 nm, 13 nm etc.).

As is illustrated in FIG. 2, the corresponding light beams emitted by the light source 15 are deflected on passing through the photomask 13 (in particular at the edges or gaps of the mask structure 13a existing there), i.e. intensity maxima (first order, second order, and third order, etc. deflection maxima, here each illustrated by a beam A′, B′, and C′) occur behind the photomask 13—at specific angles β₁, β₂, β₃, etc.

The lens system 14 (or its first lens element, respectively) has a relatively large aperture angle α, in particular an aperture angle of e.g. α>50° or α>60°, or an aperture angle of e.g. α>65° or α>75°, respectively.

As is further illustrated in FIG. 2, in the embodiment shown there, a (hatched) area b′ between the first lens element (positioned closest to the photomask 13) of the lens system 14 and the photomask 13 is filled with an immersion liquid or an immersion gas (for which e.g. an appropriate chamber filled with the corresponding immersion liquid or the corresponding immersion gas, respectively, can be used, said chamber being, for instance, limited at the top by the photomask 13, at the bottom by the first lens element, and laterally by corresponding, separate chamber walls).

Furthermore, in the embodiment illustrated in FIG. 2—different from the optical device shown in FIG. 1—no immersion liquid is provided in the area a′ between the last lens element (positioned closest to the wafer 12) of the lens system 14 and the wafer 12 (but e.g. the gas also surrounding the rest of the optical device, in particular air (e.g. the clean room air of the clean room in which the optical device 11 is installed), or an appropriate stirring gas or cleaning gas, e.g. nitrogen (each with a refractive index of (approximately) 1)). Thus, a contamination of the photoresist layer 12b by the otherwise directly contacting immersion liquid may be prevented.

The above-mentioned immersion liquid filled in the area b′ between the first lens element of the lens system 14 and the photomask 13, or the immersion gas provided there, respectively, has a relatively high refractive index n, in particular a refractive index n greater than 1, e.g. a refractive index n>1.05 or n>1.1, or a refractive index n>1.2 or n>1.3.

The immersion liquid or the immersion gas, respectively, is preferably chosen such that its refractive index n is adjusted to the corresponding refractive index n′ of the material used for the construction of the above-mentioned first lens element and/or for the construction of the photomask 13 (e.g. quartz or calcium fluoride (CaF₂), etc.) (i.e. the corresponding refractive indices n, n′ should be as identical as possible or as little different as possible, respectively).

Furthermore, the corresponding immersion liquid or the immersion gas, respectively, is preferably transparent or to be as light-transmitting as possible (i.e. have a degree of absorption as small as possible).

As immersion liquid, e.g. water may be used (refractive index n=1.46), or e.g. perfluorpolyether (PFPE) (refractive index n=1.37).

The relatively high refractive index n of the immersion liquid or of the immersion gas, respectively, results in that, in the,optical device 11 illustrated in FIG. 2 (in particular in the lens system 14 or its first lens element, respectively), the so-called numerical aperture NA (defined as NA=n×sin α (with α being the aperture angle, n being the refractive index)) is relatively large, in particular larger than is the case with corresponding, conventional optical devices 1 (cf. e.g. FIG. 1) where the area b between the first lens element of the lens system 4 and the photomask 3 is filled with air.

By the increased numerical aperture NA—caused by the above-mentioned relatively high refractive index n—it is achieved that the beams A′, B′, and C′ representing intensity maxima of a relatively high order (here e.g. first order, second order, and third order), are also covered or collected, respectively, by the lens system 14, in particular by its first lens element (and not—as is e.g. illustrated in FIG. 1—just the intensity maxima of the first order and second order) (or, alternatively, e.g. with a smaller or a distinctly smaller aperture A than is the case in the optical devices 1, 11 illustrated in FIGS. 1 and 2, nevertheless the beams A′, or A′ and B′, respectively, etc. representing the intensity maxima of the first order, or of the first order and second order, respectively, are collected).

As is further illustrated in FIG. 2, the above-mentioned beams A′, B′ and C′ representing intensity maxima of a relatively high order are, by the lens system 14 or its last lens element, respectively, all projected on the surface of the wafer 12 (or the photoresist layer 12b, respectively). This improves the quality of the structure image projected by the lens system 14 on the wafer 12 (more exactly: the photoresist layer 12b) (thus enabling a smaller minimum structure size CD (CD=critical dimension) to be realized on the wafer 12).

In detail, the minimum structure size CD that can be obtained on the wafer 12 with the optical device 11 illustrated in FIG. 2 may be calculated by means of the following formula:

CD=(0.5×λ)/NA

(with NA being the above-mentioned numerical aperture, and λ being the wavelength of the light used for exposure of the wafer 12 (here e.g. 365 nm, 248 nm, 193 nm, 157 nm, or 13 nm, etc. (cf. above))).

The above-explained relatively high numerical aperture NA of the optical device 11 illustrated in FIG. 2 thus results—in correspondence with the above formula—in a distinctly smaller, minimum structure size CD that can be realized on the wafer 12, as compared to conventional optical devices.

FIG. 3 is a schematic cross-sectional view of an optical device 101 for the production of semiconductor devices in accordance with a second embodiment of the present invention.

The optical device 101 has a structure similar to that of the optical device 11 illustrated in FIG. 2.

In particular, in the optical device 101 illustrated in FIG. 3—in analogy to the optical device 11 illustrated in FIG. 2—a lens system 14 containing one or a plurality of lens elements (connected in series) is provided, said lens system 14 being positioned or fastened, respectively, between a photomask 103 and a wafer 102.

The photomask 103 may, for instance, be a conventional photomask, or, for instance, a phase shift mask (PSM), in particular an alternating phase shift mask (alternating PSM), or an attenuated phase shift mask (attenuated PSM), etc.

The photomask 103 is provided with a mask structure 103a corresponding to the respective structure to be produced on the wafer 102 (wherein—as will be explained in more detail further below—the mask structure 103a is, by means of the optical device 101, projected on the wafer 102 in a correspondingly reduced way).

At the top of the wafer 102—which is, for instance, manufactured of monocrystalline silicon—an oxide layer 102a is provided on which a light-sensitive photoresist layer 102b has been applied.

A light source 105, e.g. an appropriate laser, or e.g. a mercury vapor lamp, an argon discharge lamp, etc. is provided for exposure of the photomask 103 (and thus also of the structure on the photoresist layer 102b corresponding to the mask structure 103a) (with a further lens system 106 containing one or a plurality of lens elements being provided between the light source 105 and the photomask 103).

The light source 105 may, for instance, emit light of a wavelength λ of 193 nm (or, for instance, of a wavelength λ of 365 nm, 248 nm, 157 nm, 13 nm etc.).

As is illustrated in FIG. 3, the corresponding light beams emitted by the light source 105 are deflected on passing through the photomask 103 (in particular at the edges or gaps of the mask structure 103a existing there), i.e. intensity maxima (first order, second order, and third order, etc. deflection maxima) occur behind the photomask 103—at specific angles β₁″, β₂″, β₃″.

The lens system 104 (or its first lens element, respectively) has a relatively large aperture angle α, in particular an aperture angle of e.g. α>50° or a >60°, or e.g. an aperture angle of e.g. α>65° or a >75°.

As is further illustrated in FIG. 3, in the embodiment shown there—like in the optical device 11 illustrated in FIG. 2—, an (also hatched) area b″ between the first lens element (positioned closest to the photomask 103) of the lens system 104 and the photomask 103 is filled with an immersion liquid or an immersion gas (for which e.g. an appropriate chamber filled with the corresponding immersion liquid or the corresponding immersion gas, respectively, can be used, said chamber being, for instance, limited at the top by the photomask 103, at the bottom by the first lens element, and laterally by corresponding, separate chamber walls).

Furthermore, in the embodiment illustrated in FIG. 3—different from the optical device 11 illustrated in FIG. 2 (and similar to the optical device 1 illustrated in FIG. 1)—an immersion medium, in particular an immersion liquid or—particularly advantageously—an immersion gas, is also provided in the area a″ between the last lens element (positioned closest to the wafer 102) of the lens system 104 and the wafer 102 (for which e.g. an appropriate further chamber filled with the corresponding immersion liquid or the corresponding immersion gas, respectively, can be used, said chamber being, for instance, limited at the top by the last lens element, at the bottom by the wafer, and laterally by corresponding, separate chamber walls).

The immersion liquid or the immersion gas, respectively, has a relatively high refractive index n, in particular a refractive index n greater than 1, e.g. a refractive index n>1.05 or n>1.1, or a refractive index n>1.2 or n>1.3, respectively.

The corresponding immersion liquid or the immersion gas, respectively, is prferably chosen to be transparent or to be as light-transmitting as possible (i.e. have a degree of absorption as small as possible).

As immersion liquid, e.g. water may be used (refractive index n=1.46), or e.g. perfluorpolyether (PFPE) (refractive index n=1.37).

The relatively high refractive index n of the immersion liquid or of the immersion gas, respectively, results in a relatively large total reflection critical angle at the immersion liquid/wafer interface or the immersion gas/wafer interface, respectively, thus preventing the beams hitting the wafer 102 from the last lens element from being reflected at the upper face of the wafer 102.

When—advantageously—an immersion gas (instead of an immersion liquid) is used in the area a″ between the last lens element and the wafer 102, the risk of the photoresist layer 102b being contaminated (by the corresponding immersion medium) is reduced.

The above-mentioned immersion liquid filled in the area b″ between the first lens element of the lens system 104 and the photomask 103, or the immersion gas provided there, respectively, has—like the immersion liquid or the immersion gas, respectively, in the area a″ between the last lens element of the lens system 104 and the wafer 102—a relatively high refractive index n, in particular a refractive index n greater than 1, e.g. a refractive index n>1.05 or n>1.1, or a refractive index n>1.2 or n>1.3, respectively.

The immersion liquid or the immersion gas, respectively, should be chosen such that its refractive index n is adjusted to the corresponding refractive index of the material used for the construction of the above-mentioned first lens element and/or for the construction of the photomask 103 (e.g. quartz or calcium fluoride (CaF₂), etc.) (i.e. the corresponding refractive indices n, n′ should be as identical as possible or as little different as possible, respectively).

Furthermore, the corresponding immersion liquid or the immersion gas, respectively, is preferably chosen to be transparent or to be as light-transmitting as possible (i.e. have a degree of absorption as small as possible).

As immersion liquid, e.g. water may be used (refractive index n=1.46), or e.g. perfluorpolyether (PFPE) (refractive index n=1.37).

The relatively high refractive index n of the immersion liquid or of the immersion gas, respectively, results in that, in the optical device 101 illustrated in FIG. 3—like in the optical device 11 illustrated in FIG. 2 (in particular in the lens system 104 or its first lens element, respectively), the numerical aperture NA=n×sin α (α=aperture angle, n=refractive index) is relatively large, in particular larger than is the case with corresponding, conventional optical devices 1 (cf. e.g. FIG. 1) where the area b between the first lens element of the lens system 4 and the photomask 3 is filled with air.

By the increased numerical aperture NA—caused by the above-mentioned relatively high refractive index n—it is achieved that the beams representing intensity maxima of a relatively high order (here e.g. first order, second order, and third order, or e.g. first order and second order, or e.g. first order to fourth order, etc.), are also covered or collected, respectively, by the lens system 104, in particular by its first lens element. This improves the quality of the structure image projected by the lens system 104 on the wafer 102 (more exactly: the photoresist layer 102b) (this enabling a smaller minimum structure size CD to be realized on the wafer 102 (in correspondence with the above-explained formula CD=(0.5×λ)/NA)).

1. An optical device for lithography comprising a lens system positioned, with respect to the optical path, behind a mask,
wherein in an area between the mask and the lens system a medium is provided which has a refractive index (n) greater than 1.

2. The optical device according to claim 1, wherein the refractive index (n) of the medium is greater than 1.1.

3. The optical device according to claim 1, wherein the refractive index (n) of the medium is greater than 1.2.

4. The optical device according to claim 1, wherein the medium is a liquid.

5. The optical device according to claim 4, wherein the liquid comprises water.

6. The optical device according to claim 4, wherein the liquid comprises perfluorpolyether.

7. The optical device according to claim 1, wherein the medium is a gas.

8. The optical device according to claim 1, wherein the lens system comprises one or a plurality of individual lenses.

9. The optical device according to claim 1, wherein the device is used for the exposure of a wafer positioned, with respect to the optical path, behind the lens system.

10. The optical device according to claim 9, wherein, in an area between the lens system and the wafer a medium is provided which has a refractive index (n) of approximately 1.

11. The optical device according to claim 10, wherein air is used as the medium provided in the area between the lens system and the wafer.

12. The optical device according to claim 9, wherein, in an area between the lens system and the wafer a medium is provided which has a refractive index (n) greater than 1.

13. The optical device according to claim 12, wherein the refractive index (n) of the medium provided in the area between the lens system and the wafer (12, 102) is greater than 1.1.

14. The optical device according to claim 13, wherein the refractive index (n) of the medium provided in the area between the lens system and the wafer is greater than 1.2.

15. The optical device according to claim 12, wherein the medium provided in the area between the lens system and the wafer is a liquid.

16. The optical device according to claim 15, wherein the liquid provided in the area between the lens system and the wafer comprises perfluorpolyether or water.

17. The optical device according to claim 12, wherein the medium provided in the area between the lens system and the wafer is a gas.

18. The optical device according to claim 1, wherein the mask is a photomask.

19. The optical device according to claim 1, wherein the mask is a phase shift mask.

20. An optical lithography method, comprising:
providing a lens system
providing a mask; and
providing a medium which has a refractive index (n) greater than 1, in an area between the mask and the lens system.
